(19) United States
(12) Patent Application Publication
(10) Pub. No.: US 2015/0104050 A1
(43) Pub. Date: Apr. 16, 2015

(54) Determining the Configuration of an Audio System For Audio Signal Processing

(71) Applicant: Imagination Technologies Limited, Kings Langley (GB)

(72) Inventor: Martin Harrison, Hertfordshire (GB)

(21) Appl. No.: 14/511,379

(22) Filed: Oct. 10, 2014

(30) Foreign Application Priority Data
Oct. 14, 2013 (GB) 1318157.3

(51) Int. Cl. H04S 7/00; G06T 7/00

(52) U.S. Cl. CPC H04S 7/303; G06T 7/004
USPC 381/303

(57) ABSTRACT

An audio system includes one or more speakers situated in an environment. The positions of components which are relevant to the audio system may be used to adapt how an audio signal is output from the speakers, in order to implement complex audio effects such as wave field synthesis and beamforming. An image of the environment is captured (e.g. with a camera) and the positions of relevant components of the environment are identified by processing the captured image. The identified positions may then be used to adapt the output of an audio signal from one or more of the speakers of the audio system. In this way it is simple to configure the audio system to suit the positions of the relevant components in the environment.

### BACKGROUND

Audio systems comprise one or more speakers for outputting audio signals to a listener. Audio systems may also comprise a controller which controls the output of the audio signals from each of the speakers of the audio system. Where there are multiple speakers in an audio system, the output of an audio signal from each of the speakers may be synchronized. An audio signal output from the speakers of an audio system will travel through the local environment (e.g. through the air) from the speakers to a listener.

Some sophisticated audio systems can introduce complex audio effects into the output of an audio signal. Often, these audio effects are produced by altering the output of the audio signal for output from different speakers of the audio system. Examples of audio effects which may be introduced in this way are wave field synthesis (WFS) and audio beamforming. Both of these audio effects rely on precisely controlling the relative timings with which an audio signal is output from each speaker of an array of speakers, such that the sound waves output from the different speakers interact with each other in such a way as to create the desired audio effect.

In particular, WFS is a spatial audio rendering technique, which is used to create virtual acoustic environments. WFS artificially produces audio wave fronts synthesized by a plurality of individually driven speakers in such a way that the wave fronts seem to originate from a virtual source location. The virtual source location (or “origin”) of the wave fronts does not depend on, or change with, the listener's position. This is in contrast to traditional spatialization techniques, such as stereo or surround sound, which have a “sweet spot” where the listener must be positioned to fully appreciate the spatial audio effect. For WFS to be effective, the position of all of the speakers within the audio system must be known to a high degree of accuracy (e.g. to millimeter precision). A controller of the audio system can use the positions of the speakers in an algorithm to determine how to control the output of an audio signal from the speakers in order to produce the desired wave field audio effect.

Audio beamforming uses a similar principle to that used by WFS systems to direct audio signals output from an array of speakers into a beam. This is achieved by ensuring that the outputted audio signals at particular angles (along the beam) experience constructive interference, while at other angles (away from the beam direction) the outputted audio signals experience destructive interference. The direction of the beam may be controllable. As with the WFS systems described above, for audio beamforming to be effective, the position of all of the speakers within the audio system must be known to a high degree of accuracy (e.g. to millimeter precision), so that a controller of the audio system can use the positions of the speakers in an algorithm to determine how to control the output of an audio signal from the speakers in order to produce the desired audio beamforming effect.

In order for the position of the speakers to be accurately determined, an array of speakers (e.g. a one dimensional or two dimensional array of speakers) may be arranged within a physical speaker box, such that the relative positions of the speakers are fixed and accurately known. This is effective in allowing the audio system to determine the relative position of the speakers, but such speaker boxes may be expensive, and inflexible in terms of the number of different uses to which the speakers can be put. As an alternative, WFS may be achieved using multiple, separate speaker units, but this requires the position of the speaker units to be measured accurately by a user (e.g. using a tape measure) so that the audio system can correctly apply WFS to the output of audio signals from the separate speaker units. The measurement of the position of the speakers is a time-consuming, and sometimes difficult task for the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

As well as the positions of the speakers of an audio system, the positions of other components in the environment in which the speakers are situated may affect an audio experience of a listener who listens to an audio signal output from the speakers of the audio system. The “other components” may include any component of the environment which is relevant to the audio system. Examples of other components which may be relevant to the audio system are a listening position at which a listener is to listen to the audio signal output from the speakers of the audio system, a display for displaying images in conjunction with the audio signal output from the speakers of the audio system, a corner of a room of the environment and an acoustically reflective surface in the environment.

There are described herein examples in which the positions of components of the environment which are relevant to the audio system can be quickly and easily identified. For example, one or more images of the environment may be captured (e.g. with a camera) and the positions of components of the environment may be identified by processing the one or more captured images of the environment. The identified positions may then be used to adapt the output of an audio signal from one or more of the speakers of the audio system. In this way it is simple to configure the audio system to suit the positions of the relevant components in the environment.

In particular, there is provided a method of configuring an audio system comprising one or more speakers, the method comprising: capturing one or more images of an environment in which the one or more speakers are situated; processing the one or more captured images to identify the positions of components of the environment which are relevant to the audio system; determining control parameters indicating how the audio system is to adapt the output of an audio signal from one or more of the speakers based on the identified positions of the components of the environment; and the audio system adapting the output of the audio signal from the one or more of the speakers in accordance with the determined control parameters.

There is also provided a processing unit arranged to configure an audio system comprising one or more speakers, the processing unit comprising: a receiver module configured to receive one or more images which have been captured of an environment in which the one or more speakers are situated; a processing module configured to: (i) process the one or more captured images to identify the positions of components of the environment which are relevant to the audio system, and (ii) determine control parameters indicating how the audio system is to adapt the output of an audio signal from one or more of the speakers based on the identified positions of the components of the environment; and an output module configured to provide the determined control parameters to the audio system.

There is also provided a computer program product configured to control an audio system comprising one or more speakers, the computer program product being embodied on a computer-readable storage medium and configured so as when executed on a processor to implement a processing unit as described herein.

There is also provided a system comprising: an audio system comprising one or more speakers for outputting audio signals; at least one camera configured to capture one or more images of an environment in which the one or more speakers of the audio system are situated; and a processing unit configured to: (i) process the one or more captured images to identify the positions of components of the environment which are relevant to the audio system, and (ii) determine control parameters indicating how the audio system is to adapt the output of an audio signal from one or more of the speakers based on the identified positions of the components of the environment; wherein the audio system is configured to adapt the output of the audio signal from the one or more of the speakers in accordance with the determined control parameters.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows an environment in which speakers of an audio system are situated applicable to the present disclosure;

FIG. 2 is a functional diagram showing modules within a system according to an example of the present disclosure;

FIG. 3 shows a flow chart of a method for configuring the audio system in accordance with the present disclosure;

FIG. 4 shows markers on three speakers in different positions in accordance with an aspect of the present disclosure;

FIG. 5 shows a schematic diagram of physical elements in the system according to a first example in accordance with the present disclosure;

FIG. 6 shows a schematic diagram of physical elements in the system according to a second example in accordance with the present disclosure; and

FIG. 7 shows a schematic diagram of physical elements in the system according to a third example in accordance with the present disclosure.

Common reference numerals are used throughout the figures, where appropriate, to indicate similar features.

### DETAILED DESCRIPTION

Embodiments will now be described by way of example only.

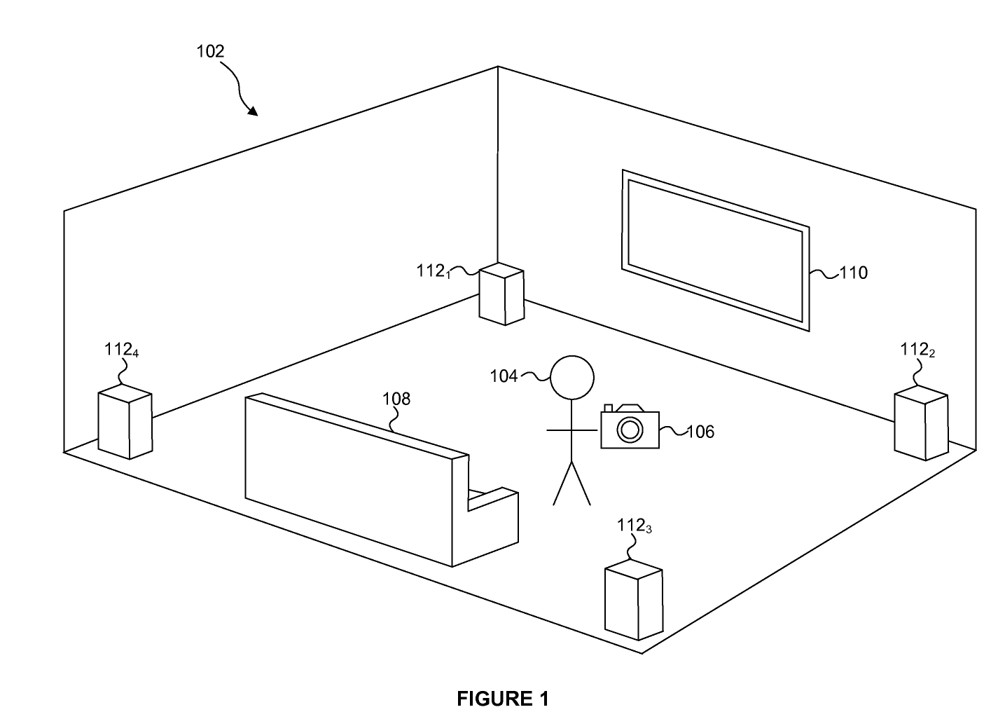

FIG. 1 shows an environment 102 in which a user 104 can listen to audio signals output from speakers 112ₙ of an audio system. The environment 102 shown in FIG. 1 is a room. As shown in FIG. 1 the user 104 has a camera 106. Also shown in FIG. 1 is a position 108 (e.g. the position of a sofa or chair) which can be designated (e.g. by the user 104) as a listening position at which the user 104 intends to listen to audio signals output from the audio system. FIG. 1 also shows a display 110 which can output images which are to be output in conjunction with the output of audio signals from the audio system, e.g. when the audio system is arranged to output the audio signals from a video program which is displayed on the display 110. FIG. 1 also shows four speakers of the audio system denoted 112₁, 112₂, 112₃ and 112₄.

As described in detail below, the audio system may adapt the output of an audio signal from one or more of the speakers 112ₙ based on the positions of components of the environment which are relevant to the audio system (e.g. the positions of the speakers 112ₙ, the listening position 108, the position of the display 110, the position of corners of the room, and/or the position of acoustically reflective surfaces in the environment 102 such as the walls or ceiling of the room or other acoustically reflective surfaces in the environment 102 which are not shown in FIG. 1). In particular, the output of an audio signal from one or more of the speakers 112ₙ may be adapted to suit the positions of the components within the environment 102. The positions of the relevant components within the environment 102 may be identified by using a camera (e.g. the user's camera 106) to capture one or more images of the environment 102, and then performing some image processing on the captured image(s) to identify the positions of the components within the environment 102. The nature of the image processing that is performed on the captured image(s) may differ in different examples, as described in more detail below, but in all of the examples, most, or all, of the image processing is performed electronically (e.g. by a processing unit), such that the user's involvement in the process is not extensive. This simplifies, for the user 104, the process of configuring the audio system as compared to prior art systems. In particular, in some examples, the user 104 simply captures the image(s) of the environment using the camera 106 and then the rest of the steps of configuring the audio system are performed automatically. In some examples, the user 104 is not required to perform any steps, whereby a camera (e.g. a fixed camera within the environment 102) may automatically identify the positions of relevant components within the environment 102 and the audio system is automatically adapted according to the positions of the components within the environment. In other examples, the user 104 may provide some user input to confirm the positions of the components identified automatically by an electronic image processing step.

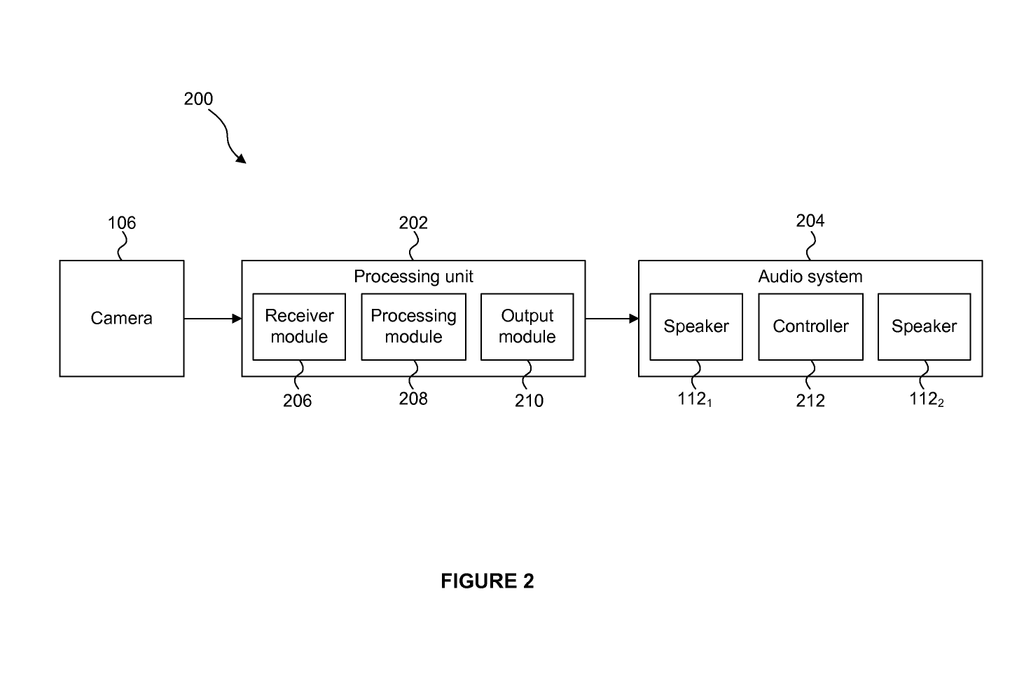

FIG. 2 shows a system 200 comprising functional modules which can be used to configure an audio system. In particular, the system 200 comprises the camera 106, a processing unit 202 and the audio system 204. The processing unit 202 comprises a receiver module 206, a processing module 208 and an output module 210. The audio system 204 comprises a controller 212 and a plurality of speakers 112 (two of which are shown in FIG. 2 denoted 112₁ and 112₂). The controller 212 of the audio system 204 controls the output of the audio signals from the speakers 112 of the audio system 204. The controller 212 may be implemented in software for execution on a processor. Alternatively, the controller 212 may be implemented in hardware. The controller 212 may be implemented physically in the same location as one of the speakers, or as a separate physical unit to all of the speakers 112 of the audio system 204. The system 200 may be referred to as a “networked system” because the elements of the system 200 can communicate with each other over a network, e.g. via wireless or wired network connections.

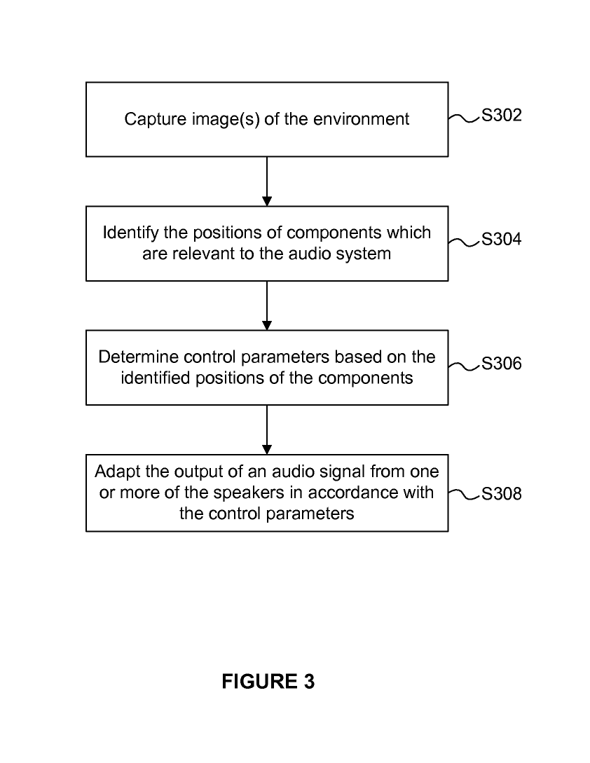

The operation of the system 200 is described with reference to the flow chart shown in FIG. 3. In step S302 one or more images of the environment 102 are captured using the camera 106. The camera 106 may be implemented in a mobile device (or “handheld” device) as shown in FIG. 1 such that the user 104 can easily capture images of the environment 102 with the camera 106. For example, the camera 106 may be implemented in a smartphone or tablet which may also be capable of communicating over a network such as the Internet. In other examples, the camera 106 may be implemented as a fixed camera, which is not intended to be a handheld device for the user 104. That is a fixed camera may be situated in a particular position within the environment 102 and might not be moved frequently, such that the fixed camera may maintain a view of the environment 102. In this way the camera 106 may determine when components of the environment 102 have been moved or when components have been added to, or removed from, the environment 102. The camera 106 may be sensitive to light from a particular section of the electromagnetic spectrum. For example, the camera 106 may be sensitive to visible light and/or infrared light. Often, cameras are sensitive to both visible and infra-red light. Alternatively, the camera 106 may comprise depth sensors for detecting the distance from the camera 106 to objects in the environment 102. As an example, the camera 106 may emit infrared light and use the depth sensors to measure how long it takes the beams of infrared light to reflect off objects in the environment 102 and return to the camera 106, to thereby create a depth map of the environment 102. A depth map created in this way is an accurate way to model the positions of objects within the environment 102. This is just one example of how the camera 106 may detect the distance from the camera 106 to objects in the environment 102, and a person skilled in the art may know of other ways in which this could be achieved.

In the example shown in FIG. 1 there is just one camera 106 which captures the images of the environment 102. In other examples, more than one camera (of any suitable type) may be used to capture the images of the environment 102. In this way, the images of the environment 102 may be taken from one or more viewpoints. An example in which multiple viewpoints of the environment 102 are used is when the camera 106 is a 3D camera which captures two different viewpoints of the environment 102 corresponding to the views from left and right eyes respectively.

The captured one or more images are passed from the camera 106 to the processing unit 202. The receiver module 206 of the processing unit 202 is configured to receive the captured image(s) from the camera 106. In some examples, the camera 106 is implemented at a different device to the processing unit 202, in which case the receiver module 206 may act as a network interface to receive the captured image(s) from the camera 106 over a network (e.g. the Internet). In other examples, the camera 106 is implemented at the same device as the processing unit 202, in which case the receiver module 206 may simply be an internal interface for receiving the captured image(s) at the processing unit 202 from the camera 106.

In step S304 the processing module 208 processes the captured image(s) to identify the positions of components of the environment 102 which are relevant to the audio system 204. The image processing performed by the processing module 208 in step S304 may analyse the captured image(s) to identify particular features in the captured image(s) which are indicative of relevant components of the environment 102. In this way the positions of components of the environment 102 which are relevant to the audio system 204 can be quickly and easily identified automatically. As described above, relevant components of the environment 102 may include the speakers 112, the listening position 108, the television 110, corners of the room and/or other acoustically reflective surfaces in the environment 102 such as the walls and ceiling of the room.

Where more than one image of the environment is captured by the camera 106, the captured images may be combined to form a combined image of the environment 102, wherein the combined image is processed by the processing module 208 to identify the positions of the components of the environment which are relevant to the audio system 204. This allows the positions of a group of components which are not all visible within a single captured image to be identified. The images which are combined may be frames of a video sequence. In this case, the user 104 can take a video and pan around to thereby capture images of more of the environment 102 than can be seen in the field of view of a single image. The frames of the video sequence can be combined to form a combined image for use in identifying the positions of components in the environment 102. As another example, the images which are combined might not be frames of a video sequence, and instead may be separate, still images of different (but overlapping) sections of the environment 102. In this case the different images may be combined to form a combined image, e.g. using a panoramic image processing technique. The process of combining the images may be referred to as “photo-stitching”, and may be performed by the camera 106 or by the processing module 208. Where the images are of different, but overlapping, sections of the environment 102 the images may be combined by identifying which portions of the images are overlapping by comparing the images to find matching sections and combining the images by overlaying the images to line up the matching sections accordingly. Methods for combining overlapping images in this way are known in the art and as such are not described in detail herein.

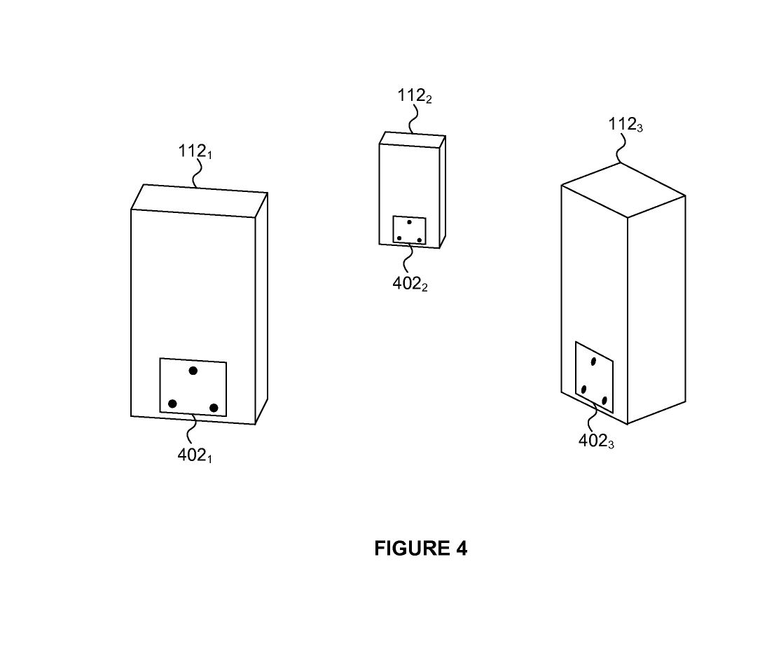

The way in which the processing module 208 processes the captured image(s) to identify the positions of the components may vary in different examples. With reference to FIG. 4 there is described one way in which the processing module 208 may identify the positions of the components. FIG. 4 represents an image that has been captured by the camera 106 and which includes three speakers 112₁, 112₂ and 112₃ of the audio system 204. As shown in FIG. 4 each of the speakers (112₁, 112₂ and 112₃) includes a respective marker 402₁, 402₂ and 402₃. The markers 402 are used to identify the objects to which the markers are attached as speakers. Therefore, in order to identify a speaker in the captured image(s), the processing module 208 may identify one of the markers in the captured image(s). Therefore, it is useful if the markers 402 are easily identifiable in the captured image(s) to the processing module 208. For this reason, the markers 402 have known characteristics which the processing module 208 can identify. The marker of a component may be indicative of the type of the component. For example, a first model (or type or brand) of speaker may have a first marker, a second model of speaker may have a second marker, whilst the display 110 may have a third marker, etc. The processing module 208 can identify the type of a component (e.g. whether it is the first model of speaker, the second model of speaker, or a television, etc.) by identifying the marker in the captured image(s).

In this example, the processing module 208 can identify a marker of a component and can determine the position of the component using the identified marker. A captured image of the environment 102 may be two a dimensional (2D) image which indicates the angle from the camera 106 to components in the environment 102 which are visible in the captured image. However, the 2D image does not (without further processing) provide information to the processing module 208 relating to the distance of a component from the camera 106. In order for the processing module 208 to determine the position of the components in the environment, the processing module 208 may need to determine the distance from the camera 106 to the components. For this purpose, each of the markers 402 may have a known size. The processing module 208 may determine the size of a marker of a component in the captured image(s) to thereby indicate a distance to that component (i.e. the distance from the camera 106 to the component). The position of the camera 106 may be known such that the angle from the camera 106 to a component as indicated by the 2D captured images of the environment 102, combined with the determined distance from the camera 106 to the component determines the position of the component. If the position of the camera 106 is not known, it may be assumed to be at fixed point for capturing the image(s) such that the relative positions of the components can be determined using the angle from the camera 106 to the component and the determined distance from the camera 106 to the component. If desired, the distance between the identified components can be determined from their positions, e.g. by triangulation.

The three speakers 112₁ and 112₂ and 112₃ shown in FIG. 4 are the same size and shape as each other and they have identical markers 402₁, 402₂ and 402₃. The speakers 112₁ and 112₃ are closer than the speaker 112₂ to the camera 106. The speakers 112₁ and 112₂ are angled such that the markers 402₁ and 402₂ substantially face the camera 106. However, the speaker 112₃ is angled such that the marker 402₃ does not substantially face the camera 106. It can be seen in FIG. 4 that the marker 402₂ of the speaker 112₂ appears smaller than the marker 402₁ of the speaker 112₁ in the captured image. This allows the processing module 208 to determine that the speaker 112₂ is further away than the speaker 112₁ from the camera 106. It can be seen that in the example shown in FIG. 4 each of the markers comprises three dots arranged into a triangle. The size of the markers is known and each of the markers extends in two dimensions by a known amount. This allows the processing module 208 to distinguish between a marker that is far away from the camera 106 but angled to substantially face the camera 106 (e.g. marker 402₂) and a marker that is closer to the camera but angled such that it does not substantially face the camera 106 (e.g. marker 402₃).

In some examples, the marker may only extend in one dimension. For example, the markers could comprise two dots (e.g. the two bottom dots but not the top dots of the markers shown in FIG. 4) or a line. These examples may make an assumption that all of the speakers are angled such that their markers face substantially directly towards the camera 106 (at least in a horizontal plane). However, it may be more accurate to use markers which extend in two dimensions such as the triangular markers shown in FIG. 4. In this way there is no assumption that all of the speakers are angled such that their markers face substantially directly towards the camera 106. The horizontal extent of the markers 402₂ and 402₃ is approximately the same in the captured image shown in FIG. 4. However, the vertical extent of the marker 402₃ is greater than the vertical extent of the marker 402₂ in the captured image shown in FIG. 4. This allows the processing module 208 to determine that the marker 402₃ (and therefore the speaker 112₃) is closer than the marker 402₂ (and therefore the speaker 112₂) to the camera 106.

The markers 402 shown in FIG. 4 are just an example of markers which could be used. In other examples, different markers may be used, e.g. of different shapes and/or sizes. The markers may be symmetrical or asymmetrical. Using markers which do not have any rotational symmetry would allow the processing module 208 to uniquely determine the orientation of the components which have those markers. For example, the processing module 208 can determine whether the component is upright or on its side or upside down, etc., which may be of relevance to how the audio system 204 is to output an audio signal from the speakers 112. The markers may be any form of visual marker which the processing module 208 can recognize in the captured image(s) and may have any suitable shape. For example, the markers may have a distinctive colour. As another example, the markers may comprise one or more infrared emitters (e.g. infrared diodes). This allows the processing module 208 to easily identify the markers in the captured image(s) by simply finding bright spots in the captured image(s) in the infrared region of the electromagnetic spectrum. The markers are positioned in a known position on their respective components such that by identifying the position of the marker, the position of its component is also identified.

The use of markers is not the only way in which the positions of the components may be identified. For example, the processing unit 202 may have information (e.g. stored in a memory which is not shown in FIG. 2) describing known physical features of components which may be relevant to the audio system 204. For example, the processing unit 202 may have information identifying the particular model of speaker that is being used by the audio system 204, and identifying physical features (e.g. the shape, size and colour) of those speakers.

The processing unit 202 may also have information of known physical features of other components, for example, a television screen usually has a flat, rectangular display which may for example be black when the television is switched off or may be bright when the television is switched on. A corner of a room may be characterised by a vertical line, and the walls and ceiling of a room may be characterised by large, flat surfaces. Furthermore, a listening position may be estimated by finding physical features that have the appearance of chairs in the environment 102.

Therefore, the processing module 208 may perform object recognition on the captured image(s) to identify a component in the environment 102 by identifying the known physical features of the component in the captured image(s). The processing module 208 can then estimate the position of the identified component based on the appearance of the known physical features of the component in the captured image(s). The size of the object in the captured image can be compared with a known size of the component (if this is available) in order to determine the distance to the object from the camera 106. Image processing techniques are known which can perform object recognition to identify particular objects within images based on known physical features of the object, and as such a detailed explanation of suitable object recognition methods which may be used is not provided herein.

The processing unit 202 may trust that it can correctly identify the positions of components by analysing the captured image(s). Alternatively, the processing unit 202 may suggest to the user 104 estimated positions of components which it has identified by analysing the captured image(s). The user 104 can then provide some input to more accurately determine the positions of the components or to identify the type of the component. That is, the processing module 208 may be arranged to provide an indication of the estimated positions of the identified components to the user 104 and to receive a user input to confirm the positions of the identified components. For example, the estimated positions of the components may be displayed to the user 104 using a display of a user device, (e.g. a handheld device such as a smartphone or tablet). The user 104 can then confirm or alter the positions of the components. The user 104 can also identify the type of the component (e.g. to identify a chair as a “listening position” or to identify a television as the “display position”). The user 104 can also remove components if the processing module 208 has mistakenly identified a component of the environment 102 as being relevant to the audio system 204. The user 104 can also add components which are relevant to the audio system 204, such as a wall, a ceiling, a corner of the room and/or a listening position which the processing module 208 might not have identified by processing the captured image(s). The interaction with the user 104 is implemented using a user interface (e.g. touchscreen and/or keypad) of the user device. As described in more detail below, the processing unit 202 may be implemented in a user device, which may also include the camera 106, in which case it is simple for the processing module 208 to provide the estimated positions of the identified components to the user 104 and receive the user input using the user interface of the user device. Alternatively, the processing unit 202 may be implemented in a different device, in which case the estimated positions of the identified components may be transmitted to the user device over a network (e.g. over the Internet or over a local network such as over a WiFi connection), and the user's input may similarly be transmitted from the user device to the processing unit over the network.

The processing module 208 may build a model of the environment 102 using the identified positions of the components of the environment 102. The model is a 3D computer model which indicates the positions of the components in the environment 102. The model may be rendered and displayed to the user 104 in such a way that the user can interact with the model in order for the user 104 to provide the user input to confirm the positions of the components within the environment 102. For example, the model of the environment 102 could be a computer-generated image representing the environment 102 (e.g. a wireframe model of the room and speakers) which can be displayed on the user device to the user 104. As another example, the model may be rendered using the images taken from the camera 106, for example to give a photorealistic view of the environment 102. Furthermore, other information relating to the environment 102 and/or the audio system 204 could be included in the model to be displayed to the user 104. For example, an estimated audio signal path could be shown on the model displayed to the user 104 and/or information about the speakers 112 (e.g. the model, type or brand of the speaker) could be indicated on the model displayed to the user 104.

In step S306 the processing module 208 determines control parameters indicating how the audio system 204 is to adapt the output of an audio signal from one or more of the speakers 112 based on the identified positions of the components of the environment 102. In particular, the processing module 208 may use the model to determine the control parameters. That is, the processing module 208 can use the identified positions of the components (e.g. the speakers 112, listening position 108, display 110, etc.) to determine how the audio system 204 should output an audio signal from the speakers 112. In this way, audio effects which rely on the positions of the components of the environment 102 can be implemented in the audio system 204 using the identification of the positions of the components by the processing module 208 based on the captured image(s) as described herein.

The output module 210 of the processing unit 202 provides the determined control parameters to the audio system 204. In step S308 the audio system 204 adapts the output of the audio signal from one or more of the speakers 112 in accordance with the control parameters determined in step S306.

The control parameters specify how the audio system 204 should output an audio signal from the speakers 112 of the audio system 204. For example, the control parameters may specify the relative timings and/or phase with which the audio signal is to be output from different speakers 112 of the audio system 204. The relative timings of the output of the audio signals can be controlled by applying different delays to the output of the audio signal from different speakers 112. The relative timings and/or phase with which different instances of an audio signal are output from different speakers affects the way in which the instances of the audio signal output from the different speakers will interact (e.g. constructively or destructively interfere) with each other. Therefore, audio effects such as wave field synthesis and beamforming can be implemented by adapting the relative timings and/or phase with which an audio signal is output from different speakers. For example, in some audio systems, such as an audio system implementing audio beamforming, the position of the listener may be taken into account such that the audio signal can be directed towards the listener. Furthermore, with wave field synthesis the position of the display 110 which displays images in conjunction with an audio signal output from the audio system 204 may be taken into account, e.g. such that the audio signal can be outputted in such a way that a virtual source appears to be located at the position of the display 110.

As another example, the control parameters may specify the strength with which the audio signal is output from one or more of the speakers 112 of the audio system 204. For example, the strength of the audio signal output from each of the speakers 112ₙ may be adapted based on the positions of the speakers 112ₙ in relation to the listening position 108. For example, if the listening position 108 is very close to one of the speakers (e.g. rear speaker 112₃) the strength of the audio signal output from that speaker (e.g. the rear speaker 112₃) may be reduced and/or the strength of the audio signal output from other speakers (e.g. speakers 112₁, 112₂ and/or 112₄) may be increased. This may be done to balance the volume of the audio signal from the set of speakers 112ₙ of the audio system 204 as perceived at the listening position 108. The term “strength” is used herein to indicate any measure of audio loudness, which may for example be the sound pressure level (SPL) of the audio signal.

As another example, the control parameters may specify how the audio system 204 should move at least one of the speakers 112 of the audio system 204 based on the identified positions of the components of the environment 102. For example, some speakers may be angled upwards from the horizontal with the aim of bouncing audio signals off the ceiling to the listening position 108. This may be done to give the impression to the listener that the audio signal is coming from above. The angle with which a particular speaker should be directed to achieve this effect will depend upon the position of the particular speaker 112, the position of the ceiling and the listening position 108. Therefore, the processing module 208 can use the identified positions of the particular speaker 112, the ceiling and the listening position 108 to determine the control parameters such that they specify how to move the particular speaker 112 to correctly direct the audio signal to bounce off the ceiling before arriving at the listening position 108. The speaker may be automatically moved by the audio system 204. The speakers may be moved in other ways to create other effects, and the control parameters may specify how the audio system 204 should move the speakers accordingly. In other examples, the control parameters determined by the processing module 208 may be used to provide an indication to the user 104 (e.g. using the user interface of a user device, which may include the camera 106) of how one or more of the speakers 112ₙ should be moved, e.g. rotated or repositioned, in order to optimise the audio experience. In these examples it is the user 104 that will then move the speakers 112ₙ according to the indication.

The speakers 112ₙ of the audio system 204 may be arranged next to each other to form an array. The array of speakers can be used to implement complex audio effects such as wave field synthesis and audio beamforming as described above. The positions of the speakers can be determined as described above by using the camera 106 to capture an image of the speakers and processing the captured image to precisely identify the positions of each of the speakers in the array (e.g. to millimetre precision). The control parameters may indicate the precise positions of the speakers, which the controller 212 of the audio system 204 can then use to determine how to adapt the output of an audio signal from the different speakers 112ₙ to create the desired audio effect. For example, the audio system 204 may adapt the relative timings with which the audio signal is output from different ones of the speakers 112ₙ of the audio system 204 to thereby implement wave field synthesis of the audio signal. In this way, the relative positions of the speakers does not need to be physically fixed in a speaker box and a user does not need to manually measure the positions of the speakers with a tape measure or other similar measuring device, as in the prior art systems mentioned in the background section above. Instead the positions of the speakers 112ₙ can be identified by capturing images of the speakers and processing those images as described herein. This allows great flexibility for the user 104 to move the speakers 112ₙ around within the environment 102 or add or remove speakers from the environment 102, whilst still allowing complex audio effects such as WFS and audio beamforming to be implemented. It also greatly simplifies, for the user, the process of measuring the positions of the speakers, and may result in more accurate measurements compared to manually measuring the positions of the speakers with a measuring device such as a tape measure.

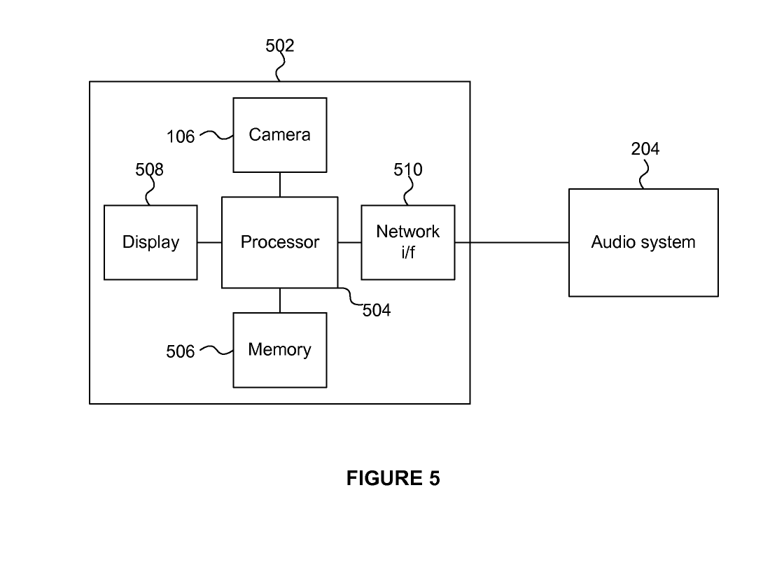

The different functional modules of the system 200 shown in FIG. 2 may be implemented in different physical elements in different examples. Some arrangements of the how the functional modules may be implemented in physical elements are shown in FIGS. 5 to 7, but in other examples the functional modules may be arranged in different physical elements to the arrangements shown in FIGS. 5 to 7.

FIG. 5 shows an example in which the processing unit 202 and the camera 106 are implemented within a device 502 which can communicate (e.g. over a network) with the audio system 204. The device 502 comprises the camera 106, a processor 504 (e.g. a CPU), a memory 506, a display 508 and a network interface 510. The device 502 may comprise other elements which, for clarity, are not shown in FIG. 5. The device 502 may be a mobile device, e.g. a handheld device such as a smartphone or a tablet, which the user 104 can use. The processing unit 202 is implemented in software in this example, as a computer program product embodied on a computer-readable storage medium (stored in the memory 506) which when executed on the processor 504 will implement the processing unit 202 as described above. In this way, the processing unit 202 is implemented as an application (or “app”) executed on the processor 504.

The display 508 (which may be a touchscreen) can be used as part of a user interface allowing the device 502 to interact with the user 104, e.g. for providing estimated positions of components to the user 104 and for receiving the user input as described above. The network interface 510 allows the device 502 to communicate with the audio system 204 over a network. For example, the network interface 510 may allow the device 502 to communicate with the audio system 204 via one or more of: an Internet connection, a WiFi connection, a Bluetooth connection, a wired connection, or any other suitable connection between the device 502 and the audio system 204. The control parameters determined by the processing unit 202 (as implemented in software running on the processor 504) may be transmitted from the processing unit 202 (i.e. from the device 502) to the audio system 204 using the network interface 510.

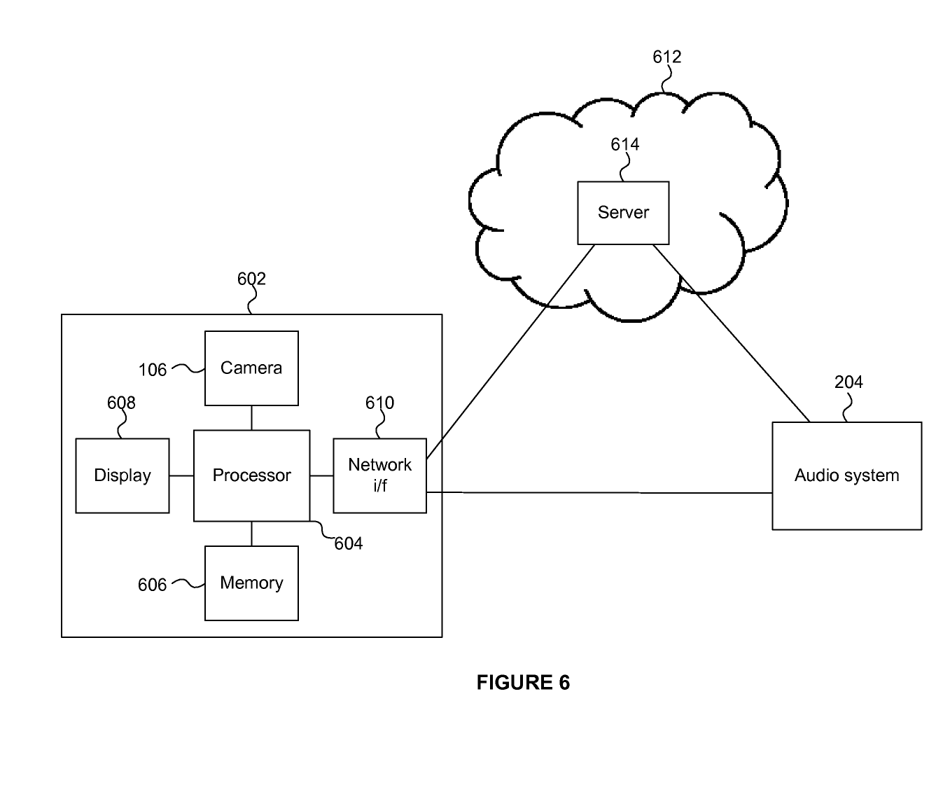

FIG. 6 shows an example in which the processing unit 202 is implemented at a server 614 within the Internet 612. The camera 106 is implemented within a device 602. The device 602 comprises the camera 106, a processor 604 (e.g. a CPU), a memory 606, a display 608 and a network interface 610. The device 602 may comprise other elements which, for clarity, are not shown in FIG. 6. The device 602 may be a mobile device, e.g. a handheld device such as a smartphone or a tablet, which the user 104 can use. The device 602 is arranged to communicate with the server 614 and with the audio system 204 using the network interface 610. The server 614 may also be arranged to communicate with the server 204 as shown in FIG. 6, although in some examples the server 614 may communicate indirectly with the audio system 204 via the device 602, such that the server 614 is not required to communicate directly with the audio system 204.

An application (or “app”) may be executed on the processor 604 of the device 602 to provide a user interface for the configuration of the audio system 204 to the user 104. The user 104 can interact with the application to provide the captured image(s) from the camera 106 to the application, and the application can then send the data to the server 614. The server 614 implements the processing unit 202 to perform the image processing on the captured image(s) to determine the control parameters based on which the audio system 204 is to adapt the output of an audio signal from the speakers 112 of the audio system 204. It may be beneficial to perform the image processing at the server 614 rather than at the device 602 because the image processing may be a relatively computationally complex task, and the processing resources available at the device 602 may be more limited than those available at the server 614. For example, this may be the case where the device 602 is a handheld device 602 which is designed to be battery powered and lightweight. If the processing unit 202 requests to receive some user input (e.g. as described above to confirm the estimated positions of components in the environment 102) then the server 614 will communicate with the device 602 to thereby communicate with the user 104 using the user interface of the application executing on the processor 604 of the device 602. The control parameters determined by the processing unit 202 are transmitted from the server 614 to the audio system 204, e.g. directly or indirectly via the device 602.

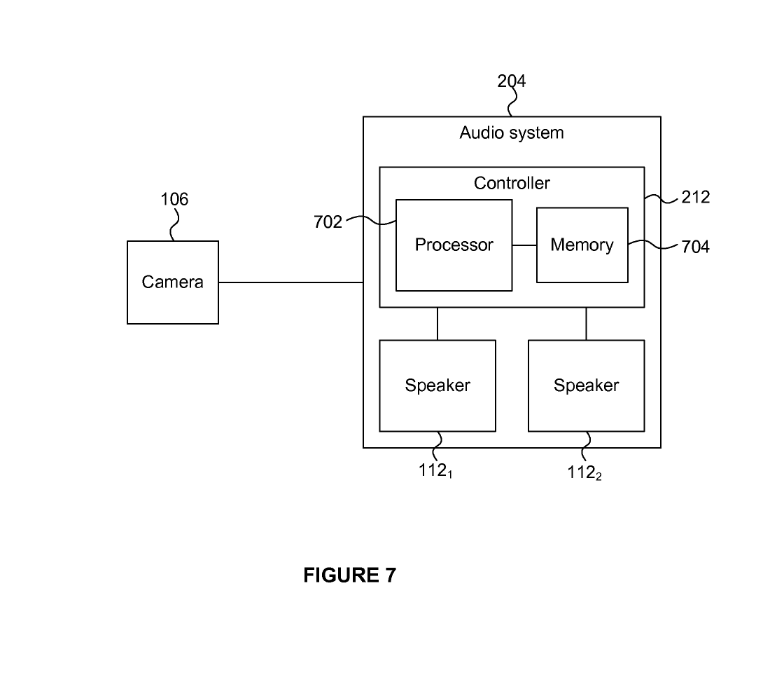

FIG. 7 shows an example in which the processing unit 202 is implemented as part of the audio system 204. As shown in FIG. 7 the audio system 204 comprises a controller 212 and two speakers 112₁ and 112₂. The controller 212 comprises a processor 702 and a memory 704. The camera 106 may be implemented in a mobile device, e.g. a handheld device such as a smartphone or a tablet, which the user 104 can use. The camera 106 is arranged to communicate with the audio system 204 over a network, to thereby transmit the captured image(s) to the audio system 204. The receiver module 206 of the processing unit 202 is configured to receive the captured image(s) from the camera 106. The processing unit 202 is implemented in software in this example, as a computer program product embodied on a computer-readable storage medium (stored in the memory 704) which when executed on the processor 702 will implement the processing unit 202 as described above. In this way the processing unit 202, at the audio system 204, can identify the positions of the components of the environment based on the captured image(s) received form the camera 106, determine the control parameters and adapt the output of an audio signal from the speakers 112₁ and 112₂ based on the control parameters such that the output of the audio signal is adapted to suit the positions of the components in the environment.

There is therefore provided a flexible system whereby components of the environment are not fixed, and the audio system 204 can be quickly and easily adapted (from the point of view of the user 104) in accordance with the positions of the components which are relevant to the audio system 204. In this way the audio system 204 is dynamically configurable to suit the current environment 102.

In the examples described above, the processing unit 202, and the modules therein (the receiver module 206, the processing module 208 and the output module 210) may be implemented in software for execution on a processor, in hardware or in a combination of software and hardware.

In the examples described above with reference to FIG. 1, the environment 102 is a room. In other examples, the environment could be any location, and may for example be outdoors. For example, an outdoor concert could use the methods described herein to determine the positions of the relevant components (e.g. speakers, stage, listening position, etc.) using a camera and to adapt the output of an audio signal from the speakers accordingly.

Generally, any of the functions, methods, techniques or components described above can be implemented in modules using software, firmware, hardware (e.g., fixed logic circuitry), or any combination of these implementations. The terms “module,” “functionality,” “component”, “block” and “unit” are used herein to generally represent software, firmware, hardware, or any combination thereof.

In the case of a software implementation, the module, functionality, component or unit represents program code that performs specified tasks when executed on a processor (e.g. one or more CPUs). In one example, the methods described may be performed by a computer configured with software in machine readable form stored on a computer-readable medium. One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The software may be in the form of a computer program comprising computer program code for configuring a computer to perform the constituent portions of described methods or in the form of a computer program comprising computer program code means adapted to perform all the steps of any of the methods described herein when the program is run on a computer and where the computer program may be embodied on a computer readable medium. The program code can be stored in one or more computer readable media. The features of the techniques described herein are platform-independent, meaning that the techniques may be implemented on a variety of computing platforms having a variety of processors.

Those skilled in the art will also realize that all, or a portion of the functionality, techniques or methods may be carried out by a dedicated circuit, an application-specific integrated circuit, a programmable logic array, a field-programmable gate array, or the like. For example, the module, functionality, component or unit may comprise hardware in the form of circuitry. Such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnects, by way of example. Such elements may be provided as custom circuits or standard cell libraries, macros, or at other levels of abstraction. Such elements may be interconnected in a specific arrangement. The module, functionality, component or logic may include circuitry that is fixed function and circuitry that can be programmed to perform a function or functions;

such programming may be provided from a firmware or software update or control mechanism. In an example, hardware logic has circuitry that implements a fixed function operation, state machine or process.

It is also intended to encompass software which “describes” or defines the configuration of hardware that implements a module, functionality, component or unit described above, such as HDL (hardware description language) software, as is used for designing integrated circuits, or for configuring programmable chips, to carry out desired functions. That is, there may be provided a computer readable storage medium having encoded thereon computer readable program code for generating a processing unit configured to perform any of the methods described herein, or for generating a processing unit comprising any apparatus described herein.

The term ‘processor’ and ‘computer’ are used herein to refer to any device, or portion thereof, with processing capability such that it can execute instructions, or a dedicated circuit capable of carrying out all or a portion of the functionality or methods, or any combination thereof.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood that the benefits and advantages described above may relate to one example or may relate to several examples.

Any range or value given herein may be extended or altered without losing the effect sought, as will be apparent to the skilled person. The steps of the methods described herein may be carried out in any suitable order, or simultaneously where appropriate. Aspects of any of the examples described above may be combined with aspects of any of the other examples described to form further examples without losing the effect sought.

1. A method of determining a configuration of an audio system comprising one or more speakers, the method comprising:
capturing one or more images of an environment in which the one or more speakers are situated;
processing the one or more captured images to identify the positions of components of the environment which are relevant to the audio system wherein one or more of the components includes a marker which has known characteristics including a known size, and wherein said processing of the one or more captured images comprises identifying a marker of a component in the one or more captured images and determining the position of the component using the identified marker including determining the size of the identified marker in the one or more captured images to thereby indicate a distance to the component;
determining control parameters indicating how the audio system is to adapt the output of an audio signal from one or more of the speakers based on the identified positions of the components of the environment; and
adapting the output of the audio signal from the one or more of the speakers in accordance with the determined control parameters.

2. The method of claim 1 wherein the audio system comprises a plurality of speakers, and wherein the control parameters are determined such that said adapting the output of an audio signal from one or more of the speakers comprises adapting the relative timings or the phase with which the audio signal is output from different ones of the speakers of the audio system.

3. The method of claim 1 wherein the control parameters are determined such that said adapting the output of an audio signal from one or more of the speakers comprises either: (i) adapting the strength with which the audio signal is output from one or more of the speakers of the audio system, or (ii) moving at least one of the speakers of the audio system.

4. The method of claim 1 wherein each of the markers comprises at least one of:
(i) one or more infra-red emitters, and
(ii) a visual marker.

5. The method of claim 1 wherein the one or more images are captured using at least one camera including one or more of:
(i) a camera in a mobile device;
(ii) a depth of field camera; and
(iii) a fixed camera.

6. A processing unit arranged to determine a configuration of an audio system comprising one or more speakers, the processing unit comprising:
a receiver module configured to receive one or more images which have been captured of an environment in which the one or more speakers are situated;
a processing module configured to:
(i) process the one or more captured images to identify the positions of components of the environment which are relevant to the audio system wherein one or more of the components includes a marker which has known characteristics including a known size, and wherein the processing module is configured to: (a) process the one or more captured images to identify a marker of a component in the one or more captured images, and
(b) determine the position of the component using the identified marker including determining the size of the identified marker in the one or more captured images to thereby indicate a distance to the component; and
(ii) determine control parameters indicating how the audio system is to adapt the output of an audio signal from one or more of the speakers based on the identified positions of the components of the environment; and
an output module configured to provide the determined control parameters to the audio system.

7. The processing unit of claim 6 wherein each of the markers extends in two dimensions by a known amount.

8. The processing unit of claim 6 wherein at least one of the markers does not have rotational symmetry.

9. The processing unit of claim 6 wherein the processing module is further configured to build a model of the environment using the identified positions of the components of the environment, wherein the processing module is configured to determine the control parameters using the model.

10. The processing unit of claim 9 wherein the processing module is further configured to output the model for display to a user, wherein the model is one of:
(i) a computer-generated image representing the environment; and
(ii) rendered using the one or more captured images.

11. The processing unit of claim 6 wherein the components of the environment comprise at least one of:
(i) one or more of the speakers of the audio system;
(ii) a listening position at which a listener is to listen to the audio signal output from the speakers of the audio system;
(iii) a display for displaying images in conjunction with the audio signal output from the speakers of the audio system;
(iv) a corner of a room of the environment; and
(v) an acoustically reflective surface.

12. The processing unit of claim 6 wherein the marker of a component is indicative of the type of the component, and wherein the processing module is further configured to identify the type of a component using a marker identified in the one or more captured images.

13. The processing unit of claim 6 wherein said components comprise speakers of the audio system and wherein the determined control parameters indicate how the audio system is to adapt the output of the audio signal from the one or more of the speakers based on the identified positions of the speakers.

14. The processing unit of claim 13 wherein the processing module determines the control parameters to indicate how the audio system is to adapt the relative timings with which the audio signal is output from different ones of the speakers of the audio system based on the identified positions of the speakers to thereby implement wave field synthesis of the audio signal.

15. The processing unit of claim 6 wherein the processing module is further configured to:
perform object recognition on the one or more captured images to identify a component in the environment by identifying known physical features of the component in the one or more captured images; and
estimate the position of the identified component based on the appearance of the known physical features of the component in the one or more captured images.

16. The processing unit of claim 6 wherein the processing module is further configured to combine a plurality of the captured images of the environment to form a combined image of the environment, wherein the processing module is configured to process the combined image to identify the positions of the components of the environment which are relevant to the audio system.

17. A computer program product configured to control an audio system comprising one or more speakers, the computer program product comprising a non-transitory computer-readable storage medium having stored therein processor-executable instructions that cause a processor to:
receive one or more images which have been captured of an environment in which one or more speakers are situated;
process the one or more captured images to identify positions of components of the environment which are relevant to the audio system wherein one or more of the components includes a marker which has known characteristics including a known size;
process the one or more captured images to identify a marker of a component in the one or more captured images;
determine the position of the component using the identified marker including determining the size of the identified marker in the one or more captured images to thereby indicate a distance to the component;
determine control parameters indicating how the audio system is to adapt the output of an audio signal from one or more of the speakers based on the identified positions of the components of the environment; and
provide the determined control parameters to the audio system

18. A system comprising:
an audio system comprising one or more speakers for outputting audio signals;
at least one camera configured to capture one or more images of an environment in which the one or more speakers of the audio system are situated; and
a processing unit configured to:
(i) process the one or more captured images to identify the positions of components of the environment which are relevant to the audio system wherein one or more of the components includes a marker which has known characteristics including a known size, and wherein the processing unit is configured to: (a) process the one or more captured images to identify a marker of a component in the one or more captured images, and (b) determine the position of the component using the identified marker including determining the size of the identified marker in the one or more captured images to thereby indicate a distance to the component; and
(ii) determine control parameters indicating how the audio system is to adapt the output of an audio signal from one or more of the speakers based on the identified positions of the components of the environment;
wherein the audio system is configured to adapt the output of the audio signal from the one or more of the speakers in accordance with the determined control parameters.

19. The system of claim 18 wherein the at least one camera and the processing unit are implemented at a device, and wherein the device is configured to send the determined control parameters to the audio system.

20. The system of claim 18 wherein the processing unit is implemented as part of the audio system, and wherein the processing unit comprises a receiver module configured to receive the captured one or more images from the at least one camera.

21. The system of claim 18 wherein the at least one camera is implemented at a different device to the processing unit, and wherein neither the at least one camera nor the processing unit are implemented as part of the audio system, and wherein the processing unit is implemented at a server, and wherein the at least one camera is implemented at a device which is configured to communicate with the server over the Internet, and wherein the server is arranged to communicate with the audio system over the Internet.
